(19) United States
(12) Patent Application Publication
(10) Pub. No.: US 2025/0148280 A1
(43) Pub. Date: May 8, 2025

(54) TECHNIQUES FOR LEARNING CO-ENGAGEMENT AND SEMANTIC RELATIONSHIPS USING GRAPH NEURAL NETWORKS

(71) Applicant: NETFLIX, INC., Los Gatos, CA (US)

(72) Inventors: Anne O’Donnell COCOS, Swarthmore, PA (US); Baolin LI, Saugus, MA (US); Hafez ASGHARZADEH, Pleasanton, CA (US); Evan Gabriel Turitz COX, Danville, CA (US); Zijie HUANG, Los Angeles, CA (US); Sudarshan Dnyaneshwar LAMKHEDE, Sunnyvale, CA (US); Lingyi LIU, Pleasanton, CA (US); Colby J. WISE, Los Angeles, CA (US)

(21) Appl. No.: 18/905,006

(22) Filed: Oct. 2, 2024

Related U.S. Application Data
(60) Provisional application No. 63/547,534, filed on Nov. 6, 2023.

(51) Int. Cl. G06N 3/08; G06N 3/042

(52) U.S. Cl. CPC G06N 3/08; G06N 3/042

(57) ABSTRACT

One embodiment of a method for training a machine learning model includes generating a graph based on one or more semantic concepts associated with a plurality of entities and user engagement with the plurality of entities, and performing one or more operations to train an untrained machine learning model based on the graph to generate a trained machine learning model.

### CROSS-REFERENCE TO RELATED APPLICATIONS

This application claims benefit of the U.S. Provisional Patent Application titled “DETERMINING CO-ENGAGEMENT AND SEMANTIC LINKS USING NEURAL NETWORKS,” filed Nov. 6, 2023, and having Ser. No. 63/547,534. The subject matter of this related application is hereby incorporated herein by reference.

### BACKGROUND

### Field of the Invention

Embodiments of the present disclosure relate generally to computer science, machine learning, and artificial intelligence (AI) and, more specifically, to techniques for learning co-engagement and semantic relationships using graph neural networks.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the trained machine learning models can be used to guide decisions and/or perform tasks related to the data or similar data.

Within machine learning, neural networks can be trained to perform a wide range of tasks with a high degree of accuracy. Neural networks are therefore becoming more widely adopted in the field of artificial intelligence. Neural networks can have a diverse range of network architectures. In more complex scenarios, the network architecture for a neural network can include many different types of layers with an intricate topology of connections among the different layers. For example, some neural networks can have ten or more layers, where each layer can include hundreds or thousands of neurons and can be coupled to one or more other layers via hundreds or thousands of individual connections. Weights and biases associated with those connections, which are also sometimes referred to as “parameters” of the neural network, control the strength of the individual connections and affect the activation of neurons.

Search engines and recommendation systems oftentimes use machine learning models to generate results. For example, a search engine could implement one or more machine learning models to understand and interpret a user query and to rank the search results that are most relevant to the query. As another example, a recommendation system could implement a machine learning model to predict what a user may like based on patterns and correlations detected within data associated with prior user behaviors. In some cases, the machine learning models in search engines and recommendation systems are trained to learn the relationships between entities, such as media content titles or books, and semantic concepts, such as genres and storylines, that are associated with the entities. In such cases, the machine learning models can also be trained to learn co-engagement relationships between pairs of entities that arise from users engaging with both entities. Both the relationships between entities and semantic concepts, and the co-engagement relationships, can be useful in ranking search results and providing recommendations that are personalized to a given user. For example, when a given user has engaged with entities associated with certain semantic concepts, the user may be more likely to engage with similar entities that are associated with the same semantic concepts. In addition, the user may be more likely to engage with entities that other users with similar histories of co-engagements with entities have engaged with.

One drawback of implementing conventional machine learning models in search engines and recommendation systems is that many conventional machine learning models can have difficulty learning both the relationships between entities and semantic concepts and co-engagement relationships. Further, the conventional machine learning models typically need to be re-trained frequently, such as on a daily basis, in order for such models to learn about new entities. Frequently re-training the conventional machine learning models can be computationally expensive, both in terms of the computational resources and the time required to re-train those machine learning models.

As the foregoing illustrates, what is needed in the art are more effective techniques for implementing machine learning models, particularly in search engines and recommendation systems.

### SUMMARY

One embodiment of the present disclosure sets forth a computer-implemented method for training a machine learning model. The method includes generating a graph based on one or more semantic concepts associated with a plurality of entities and user engagement with the plurality of entities. The method further includes performing one or more operations to train an untrained machine learning model based on the graph to generate a trained machine learning model.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques train a graph neural network to correctly learn both the relationships between entities and semantic concepts as well as co-engagement relationships. In particular, the graph neural network is able to capture graph relationships and spatial locality better than conventional machine learning models. The graph neural network is also inductive, meaning that the graph neural network does not need to be re-trained as often as conventional machine learning models in order to learn about new entities. Instead, the previously trained graph neural network can be used to encode new entities, with the encoding capturing both the semantic and co-engagement aspects of the entity without fully re-training the graph neural network. In addition, the disclosed techniques enable the graph neural network to be effectively trained by distributing the training across multiple processors, such as multiple GPUs. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computer system configured to implement one or more aspects of the various embodiments;

FIG. 2 is a more detailed illustration of the server of FIG. 1, according to various embodiments;

FIG. 3 is a more detailed illustration of the computing device of FIG. 1, according to various embodiments;

FIG. 4 is a more detailed illustration of the model trainer of FIG. 1, according to various embodiments;

FIG. 5 is a more detailed illustration of the training module of FIG. 4, according to various embodiments;

FIG. 6 illustrates how subgraphs can be generated for training a graph neural network across multiple processors, according to various embodiments;

FIG. 7 is a more detailed illustration of the application of FIG. 1, according to various embodiments;

FIG. 8 illustrates a flow diagram of method steps for training a graph neural network using co-engagement and semantic information, according to various embodiments;

FIG. 9 illustrates a flow diagram of method steps for training a graph neural network across multiple processors, according to various embodiments; and

FIG. 10 illustrates a flow diagram of method steps for generating search or recommendation results using a trained graph neural network, according to various embodiments.

### DETAILED DESCRIPTION

As described, conventional machine learning models are oftentimes used in search engines and recommendation systems. In such cases, the machine learning models can be trained to learn both the relationships between entities and semantic concepts and the co-engagement relationships between pairs of entities resulting from users engaging with both of the entities. However, machine learning models can have difficulty learning both the relationships between entities and semantic concepts and the co-engagement relationships. Oftentimes, conventional machine learning models either cannot learn the correct relationships, or a large model that includes an enormous number of parameters is required to learn those relationships. Large models can be computationally expensive to operate, both in terms of the computational resources and the time that are required to train and to execute such models.

The disclosed techniques train and utilize a graph neural network (GNN) that learns user co-engagement with entities and semantic concept relationships. In some embodiments, a model trainer generates a semantic knowledge graph from semantic information associated with entities and historical user engagement with the entities. The semantic knowledge graph includes entity nodes representing the entities, concept nodes representing semantic concepts, links between entity nodes and concept nodes representing semantic concepts that are associated with the entities represented by the entity nodes, and links between entity nodes representing entities associated with co-engagement by users. The model trainer performs a knowledge graph embedding technique to generate feature vectors for concept nodes of the semantic knowledge graph. Then, the model trainer trains a GNN using the semantic knowledge graph, the feature vectors for concept nodes, and features associated with entity nodes. When the semantic knowledge graph is too large to be stored within the memory of a single processor during training, the model trainer generates a number of subgraphs that are stored across different processors. In such cases, the model trainer can generate the subgraphs by partitioning entity nodes in the semantic knowledge graph that are linked to other entity nodes into multiple partitions, randomly assigning each other entity node that is not linked to any entity nodes to one of the partitions, and generating each of the subgraphs to include the entity nodes from one of the partitions and all of the concept nodes in the semantic knowledge graph.

Once the GNN is trained, another semantic knowledge graph, which is created from updated semantic information and user engagement information, can be input into the trained GNN to generate embeddings of entities represented by nodes of the semantic knowledge graph. The entity embeddings can then be used by an application in any technically feasible manner, such as to generate search results or recommendations of entities.

At least one technical advantage of the disclosed techniques relative to the prior art is that the disclosed techniques train a graph neural network to correctly learn both the relationships between entities and semantic concepts as well as co-engagement relationships. In particular, the graph neural network is able to capture graph relationships and spatial locality better than conventional machine learning models. The graph neural network is also inductive, meaning that the graph neural network does not need to be re-trained as often as conventional machine learning models in order to learn about new entities. Instead, the previously trained graph neural network can be used to encode new entities, with the encoding capturing both the semantic and co-engagement aspects of the entity without fully re-training the graph neural network. In addition, the disclosed techniques enable the graph neural network to be effectively trained by distributing the training across multiple processors, such as multiple GPUs.

### System Overview

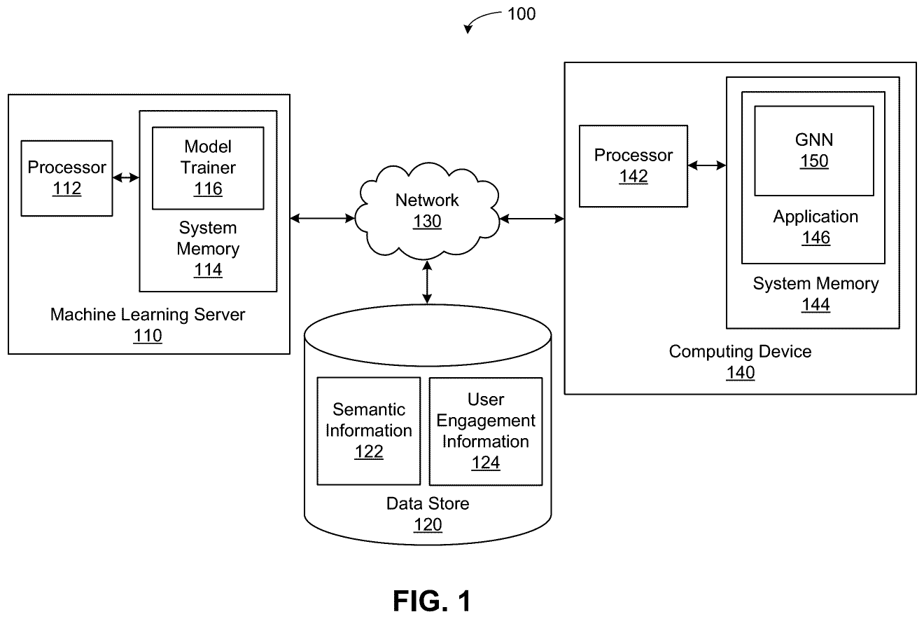

FIG. 1 illustrates a block diagram of a computer-based system 100 configured to implement one or more aspects of various embodiments. As shown, the system 100 includes a machine learning server 110, a data store 120, and a computing system 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the processor(s) 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor(s) 112 and/or the GPU(s). For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

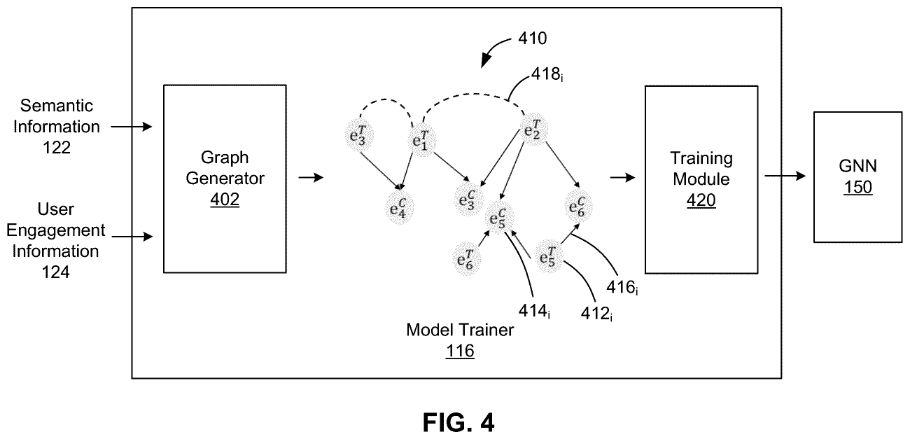

In some embodiments, the model trainer 116 is configured to train a graph neural network (GNN) 150 to learn user co-engagement with entities and semantic relationships between concepts and entities. Techniques that the model trainer 116 can employ to train the GNN 150, as well as semantic information 122 and user engagement information 124 that are stored in the data store 120 and used during the training, are discussed in greater detail below in conjunction with FIGS. 4-6 and 8-9. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

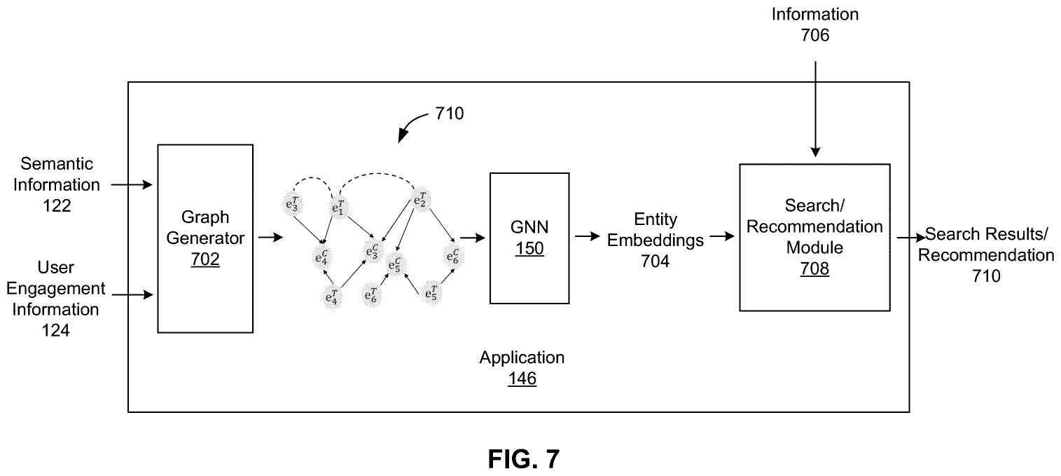

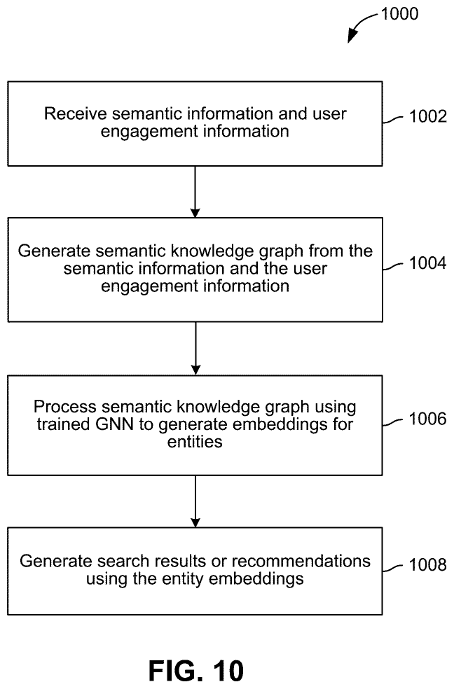

As shown, an application 146 is stored in a system memory 144, and executes on a processor 142, of the computing system 140. The application 146 can be any technically feasible application that uses the trained GNN 150. In some embodiments, the application 146 can use the trained GNN 150 to generate search results and/or recommendations. Techniques that the application 146 can use to generate search results and/or recommendations using the trained GNN 150 are discussed in greater detail below in conjunction with FIGS. 7 and 10.

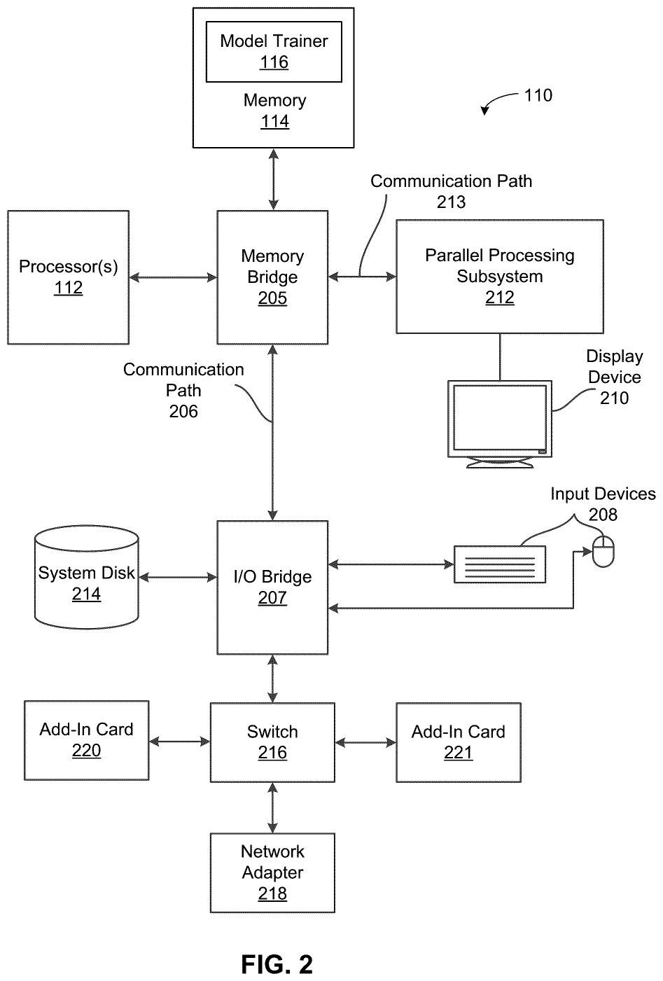

FIG. 2 is a more detailed illustration of the machine learning server 110 of FIG. 1, according to various embodiments. In some embodiments, the machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In some embodiments, the machine learning server 110 includes, without limitation, the processor(s) 112 and the system memory(ies) 114 coupled to a parallel processing subsystem 212 via a memory bridge 205 and a communication path 206. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 can be a server machine in a cloud computing environment. In such embodiments, the machine learning server 110 cannot include input devices 208, but can receive equivalent input information by receiving commands (e.g., responsive to one or more inputs from a remote computing device) in the form of messages transmitted over a network and received via a network adapter 218. In some embodiments, the switch 216 is configured to provide connections between I/O bridge 207 and other components of the machine learning server 110, such as a network adapter 218 and various add in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, can be implemented using any technically suitable protocols, including, without limitation, AGP (Accelerated Graphics Port), HyperTransport, or any other bus or point to point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the model trainer 116, which is discussed in greater detail below in conjunction with FIGS. 4-6. Although described herein primarily with respect to the model trainer 116, techniques disclosed herein can also be implemented, either entirely or in part, in other software and/or hardware, such as in the parallel processing subsystem 212.

In some embodiments, the parallel processing subsystem 212 can be integrated with one or more of the other elements of FIG. 2 to form a single system. For example, the parallel processing subsystem 212 can be integrated with the processor(s) 112 and other connection circuitry on a single chip to form a system on a chip (SoC).

In some embodiments, the processor(s) 112 includes the primary processor of the machine learning server 110, controlling and coordinating operations of other system components. In some embodiments, the processor(s) 112 issues commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, can be modified as desired. For example, in some embodiments, the system memory 114 could be connected to the processor(s) 112 directly rather than through the memory bridge 205, and other devices can communicate with the system memory 114 via the memory bridge 205 and the processor(s) 112. In other embodiments, the parallel processing subsystem 212 can be connected to the I/O bridge 207 or directly to the processor(s) 112, rather than to the memory bridge 205. In still other embodiments, the I/O bridge 207 and the memory bridge 205 can be integrated into a single chip instead of existing as one or more discrete devices. In certain embodiments, one or more components shown in FIG. 2 may not be present. For example, the switch 216 could be eliminated, and the network adapter 218 and add in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

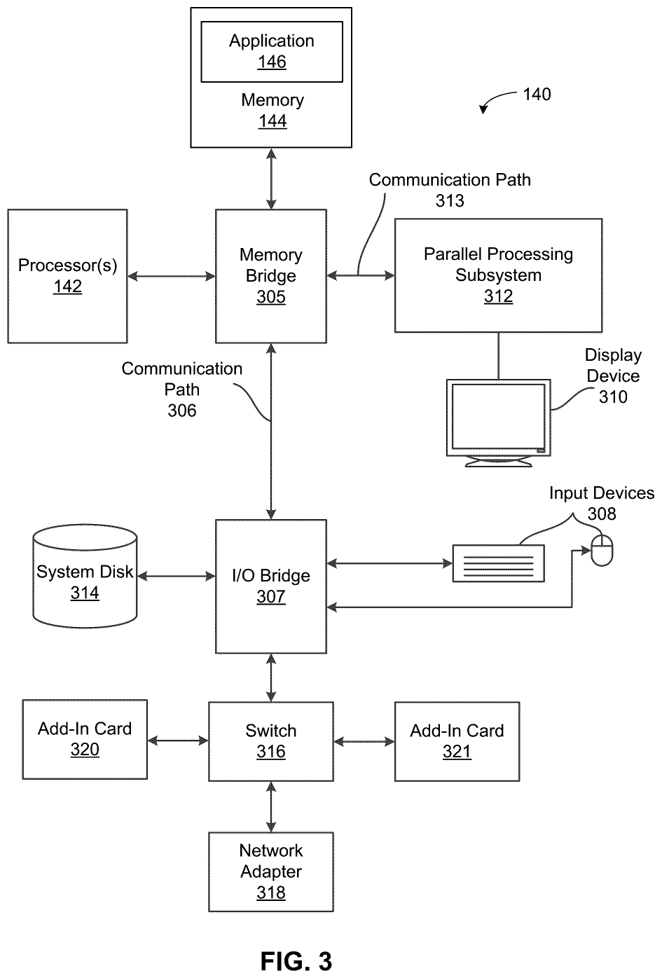

FIG. 3 is a more detailed illustration of the computing system 140 of FIG. 1, according to various embodiments. In some embodiments, the computing system 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 140 is a server machine operating in a data center or a cloud computing environment that provides scalable computing resources as a service over a network.

In some embodiments, the computing system 140 includes, without limitation, the processor(s) 142 and the memory(ies) 144 coupled to a parallel processing subsystem 312 via a memory bridge 305 and a communication path 306. Memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing system 140 can be a server machine in a cloud computing environment. In such embodiments, the computing system 140 cannot include the input devices 308, but can receive equivalent input information by receiving commands (e.g., responsive to one or more inputs from a remote computing device) in the form of messages transmitted over a network and received via a network adapter 318. In some embodiments, the switch 316 is configured to provide connections between I/O bridge 307 and other components of the computing system 140, such as a network adapter 318 and various add in cards 320 and 321.

In some embodiments, the I/O bridge 307 is coupled to a system disk 314 that may be configured to store content and applications and data for use by the processor(s) 312 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 307 as well.

In some embodiments, the memory bridge 305 may be a Northbridge chip, and the I/O bridge 307 may be a Southbridge chip. In addition, the communication paths 306 and 313, as well as other communication paths within the computing system 140, can be implemented using any technically suitable protocols, including, without limitation, AGP (Accelerated Graphics Port), HyperTransport, or any other bus or point to point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the application 146 that uses the trained GNN 150, discussed in greater detail below in conjunction with FIGS. 7 and 10. Although described herein primarily with respect to the application 146, techniques disclosed herein can also be implemented, either entirely or in part, in other software and/or hardware, such as in the parallel processing subsystem 312.

In some embodiments, the parallel processing subsystem 312 can be integrated with one or more of the other elements of FIG. 3 to form a single system. For example, the parallel processing subsystem 312 can be integrated with the processor(s) 142 and other connection circuitry on a single chip to form a system on a chip (SoC).

In some embodiments, the processor(s) 142 includes the primary processor of the computing system 140, controlling and coordinating operations of other system components. In some embodiments, the processor(s) 142 issues commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 312, and the number of parallel processing subsystems 312, can be modified as desired. For example, in some embodiments, the system memory 144 could be connected to the processor(s) 142 directly rather than through the memory bridge 305, and other devices can communicate with system memory 144 via the memory bridge 305 and the processor(s) 142. In other embodiments, the parallel processing subsystem 312 can be connected to the I/O bridge 307 or directly to the processor(s) 142, rather than to the memory bridge 305. In still other embodiments, I/O bridge 307 and the memory bridge 305 can be integrated into a single chip instead of existing as one or more discrete devices. In certain embodiments, one or more components shown in FIG. 3 may not be present. For example, the switch 316 could be eliminated, and the network adapter 318 and add the in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Learning Co-Engagement and Semantic Relationships Using Graph Neural Networks

FIG. 4 is a more detailed illustration of the model trainer 116 of FIG. 1, according to various embodiments. As shown, the model trainer 116 includes a graph generator 402 and a training module 420. In operation, the model trainer 116 takes as input the semantic information 122 and the user engagement information 124, and the model trainer 116 trains the graph neural network (GNN) 150 to learn user co-engagement with entities and the relationships between semantic concepts and entities. In some embodiments, the semantic information 122 includes semantic concepts associated with entities, and the user engagement information 124 includes historical data on user engagement (e.g., viewing, clicking on, etc.) with entities. For example, the entities could be media content titles (e.g., movie or television show titles), books, persons, and/or the like that users can engage with, and the semantic concepts could be short phrases describing concepts, such as genres, storylines, themes, content maturity levels, and/or other tags, that can be associated with entities. The semantic information 122 and the user engagement information 124 can be obtained from any suitable location or locations in some embodiments. For example, in some embodiments, the model trainer 116 can retrieve the semantic information 122 and the user engagement information 124 from the tables of a database that is stored in the data store 120.

The GNN 150 is a machine learning model, and in particular an artificial neural network, that is capable of processing graph-structured data. In some embodiments, the GNN 150 is trained to generate embeddings (e.g., in the form of vectors) of entities given a semantic knowledge graph that includes nodes representing the entities and semantic concepts, as well as links between such nodes. As shown, given the semantic information 122 and the user engagement information 124, the graph generator 402 of the model trainer 116 generates a semantic knowledge graph 410. The semantic knowledge graph 410 includes nodes 412; that represent entities (referred to herein collective as entity nodes 412 and individually as an entity node 412) and nodes 414; that represent semantic concepts (referred to herein collective as concept nodes 414 and individually as a concept node 414). As described, in some embodiments the entities can be media content titles (e.g., movie or television show titles), books, persons, and/or the like, and the semantic concepts can be related concepts, such as genres, storylines, themes, content maturity levels, and/or other tags.

The semantic knowledge graph 410 is generated to describe entities and their associated semantic concepts, such as the genres, storylines, etc. associated with media content titles. As shown, the semantic knowledge graph 410 includes links 416i (referred to herein collectively as links 416 and individually as a link 416) between entity nodes 412 and concept nodes 414 that represent semantic concepts associated with those entity nodes 412. In addition, the graph generator 402 includes links 418i (referred to herein collective as entity-entity links 416 and individually as an entity-entity link 416) between the entity nodes 412 and other entity nodes 412 that are related based on co-engagement by users. In some embodiments, each entity-entity link 418 can be added between a pair of entity nodes 416 when, within a certain period of time, more than a threshold number of users engaged with both entities represented by the pair of entity nodes 416.

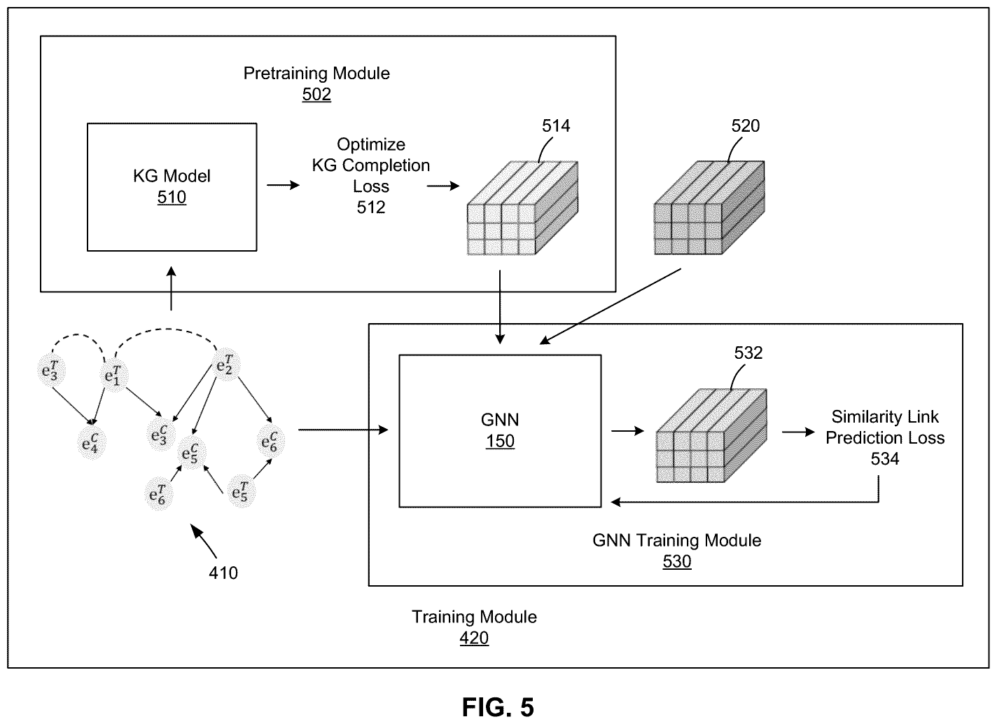

After the semantic knowledge graph 410 is generated, the training module 420 performs a pre-training step in which a knowledge graph embedding technique is applied to generate feature vectors for concept nodes of the semantic knowledge graph 410. Then, the training module 420 trains the GNN 150 using the semantic knowledge graph 410, the feature vectors for concept nodes, and features associated with the entity nodes 412, as discussed in greater below in conjunction with FIG. 5.

More formally, a semantic knowledge graph (e.g., semantic knowledge graph 410) can be represented as [symbol] (Vₜ, V_{c}, ε_{tc}, εₜₜ), where Vₜ, V_{c} are the sets of entity nodes and concepts nodes (e.g., genre) respectively. As a general matter, the number of entity nodes can be much larger than that of the concept nodes, i.e. |Vₜ|>>|V|. There are two relation sets: (1) ε_{tc} are the directed entity-concept edges where each edge e_{tc} points from an entity node vₜ to a concept node v_{c}. Let (vₜ, e_{tc}, v_{c}) denote a semantic triple such as (Entity name, has_genre, genre). Let [symbol] ={(vₜ, e_{tc}, v_{c})} denote the set of factual semantic triples. (2) εₜₜ are the undirected entity-entity links obtained from user co-engagement data where if two entities are frequently co-engaged by users, an entity-entity link would be created to denote their similarity. As a consequence of using user co-engagement data, such entity-entity links are usually sparse and only cover a small portion of titles. In some embodiments, denoising and debiasing techniques can also be applied. For example, in some embodiments, biases of co-engagement data toward popular titles can be accounted for via normalization.

Given a semantic knowledge graph [symbol] (Vₜ, V_{c}, ε_{tc}, εₜₜ), the goal of the training module 420 is to learn a GNN that effectively embeds entities to contextualized latent representations that accurately reflect their similarities. The quality of the learned embeddings can be evaluated based on different entity pair similarity measurements, as discussed in greater detail below in conjunction with FIG. 5.

Advantageously, the GNN 150 is inductive, meaning that the GNN 150 does not need to be re-trained as often as conventional machine learning models in order to learn about new entities. Instead, once trained, the GNN 150 can be used to encode new entities, with the encoding capturing both the semantic and co-engagement aspects of the entity without fully re-training the GNN 150. For example, in some embodiments, the GNN 150 can be re-trained on new training data weekly, or even monthly.

FIG. 5 is a more detailed illustration of the training module 420 of FIG. 4, according to various embodiments. As shown, the training module 420 includes a pretraining module 502 and a GNN training module 530. In operation, the pretraining module 502 performs a knowledge graph embedding (KGE) technique to generate feature vectors 514 for concept nodes (also referred to herein as concept node feature vectors 514) of the semantic knowledge graph 410. Any technically feasible knowledge graph embedding technique can be used in some embodiments. As a general matter, knowledge graph embeddings seek to acquire latent, low-dimensional representations for entities and relations, which can be utilized to deduce hidden relational facts (triples). Knowledge graph embedding techniques can measure triple plausibility based on varying score functions. Illustratively, the pretraining module 502 utilizes a knowledge graph (KG) model 510 and optimizes a KG completion loss 512 to generate the concept node feature vectors 514. The concept feature vectors 514 are embeddings for the concept nodes of the semantic knowledge graph 410, which is in contrast to directly using short phrases of the semantic concepts as textual features.

The goal of pretraining by the pretraining module 502 is to produce high-quality features for semantic concept nodes, as the concept nodes 414 are usually associated with short phrases, which may not be informative enough to serve as input features. In some embodiments, TransE can be used as the backbone KG model 510, and KG pretraining can be performed via the standard KG completion task. Any technically feasible KG embedding technique that is based on different downstream applications and KG structures can be used in some other embodiments. Specifically, let eₜ, e_{c} be the learnable embeddings of entity t, c respectively, then the model trainer 116 can train entity embeddings via the hinge loss over semantic triples [symbol] ={(vₜ, e_{tc}, v_{c})} defined as:

$${𝒥}_{K} = {{\sum }_{𝒯} [ f ( {e}_{t}^{′} , {r}_{tc} , {e}_{c}^{′} ) - f ( {e}_{t} , {r}_{tc} , {e}_{c} ) + γ ]}_{+} , \qquad ( 1 )$$

where γ>0 is a positive margin, f is the KGE model, and r_{tc} is the embedding for the relation e_{tc}·(e′ₜ, r_{tc}, e′_{c}) is a negative sampled triple obtained by replacing either the head or tail entity of the true triple (eₜ, r_{tc}, e_{c}) from the whole entity pool.

Subsequent to pretraining, the GNN training module 530 takes as input the semantic knowledge graph 410, the concept node feature vectors 514, and features 520 associated with entity nodes (also referred to herein as entity node features 520). Any suitable features 520 associated with entity nodes can be used in some embodiments. For example, for an entity that is a media content title, the associated features could include encodings of a synopsis, a tagline, etc. As another example, for an entity that is a person, the associated features could include a popularity signal, such as how many times a webpage of the person has been visited. As yet another example, for an entity that is a book, the associated features could include an encoding of a description or summary of the book. Given such inputs, the GNN training module 530 trains the GNN 150 by using an attention methodology to update parameters of the GNN 520 so as to minimize a similarity link prediction loss 534. The similarity link prediction loss 534 is a calculated so the embeddings in an embedding output 532 of the GNN 502 for entities whose nodes have an entity-entity link between them (i.e., entities associated with user co-engagement) are close in distance in a latent space, and vice versa. The training begins with an untrained GNN and generates the trained GNN 150.

In some embodiments, to handle the imbalanced relation distribution in the semantic knowledge graph 410, the GNN 150 can be an attention-based relation-aware GNN that is used to learn contextualized embeddings for entities following a multi-layer message passing architecture. Such a GNN can distinguish the influence of different neighbors of a node through attention weights. In some embodiments, the attention weights are aware of different relation types such as has_genre and has_maturity_level. For entities that lack any co-engagement, the influence of different semantic types can be distinguished to learn an informative embedding. Distinguishing relation types also helps to better represent popular entities: for a popular entity that has abundant co-engagement links, due to the learning prior weights of different relation types, the GNN is able to automatically adjust the influence received from co-engagement and semantic edges, thus preventing noisy co-engagement data from dominating its representation.

More formally, in the I-th layer of the GNN 150, the first step can involve calculating the relation-aware message transmitted by the entity vₜ in a relational fact (vₜ, e_{tc}, v_{c}) using the following procedure:

$${h}_{c ( r )}^{l} = M s g ( {h}_{c}^{l} , r ) := {W}_{v}^{l} Concat ( {h}_{i}^{l} , r ) , \qquad ( 2 )$$

where h_{c(r)}^{l} is the latent representation of v_{c} under the relation type r at the l-th layer, Concat ( [symbol] ) is the vector concatenation function, r is the relation embedding and Wᵥ^{l} is a linear transformation matrix. In addition, a relation-aware scaled dot product attention mechanism can be used to characterize the importance of the neighbor of each entity to that entity, which is computed as follows:

$$A t t ( {h}_{c ( r )}^{l} , {h}_{t}^{l} ) = \frac{exp ( {α}_{ct}^{r} )}{{\sum }_{{v}_{{c}^{′}} ∈ 𝒩 ( {v}_{t} )} exp ( {α}_{{c}^{′} t}^{r} )} \qquad ( 3 )$$

$${α}_{ct}^{r} = {( {W}_{k}^{l} {h}_{c ( r )}^{l} )}^{T} \cdot ( {W}_{q}^{l} {h}_{t}^{l} ) \cdot \frac{1}{\sqrt{d}} \cdot {β}_{r} ,$$

where d is the dimension of the entity embeddings, Wₖ^{l}, W_{q}^{l} are two transformation matrices, and βᵣ is a learnable relation factor for each relation type r. Diverging from conventional attention mechanisms, βᵣ is incorporated to represent the overall significance of each relation type r, because not all relations equally contribute to the targeted entity depending on the overall semantic knowledge graph 410 structure.

The hidden representation of entities can be updated by aggregating the message from their neighborhoods based on the attention score:

$${h}_{t}^{l + 1} = {h}_{t}^{l} + σ ( {\sum }_{{v}_{c} ∈ 𝒩 ( {v}_{t} )} A t t ( {h}_{c ( r )}^{l} , {h}_{t}^{l} ) \cdot {h}_{c ( r )}^{l} ) , \qquad ( 4 )$$

where σ(·) is a non-linear activation function, and the residual connection is used to improve the stability of GNN. In addition, L layers can be stacked to aggregate information from multi-hop neighbors and obtain the final embedding for each entity i as hᵢ=hᵢ^{L}.

Overall, given the contextualized entity embeddings, in some embodiments, the training module 420 can train the GNN 150 using the following similarity link prediction loss 534 defined over entity-entity links:

$${𝒥}_{A} = - \frac{1}{N} {\sum }_{{{e}_{ij} ∈ {ℰ}_{tt}}_{{e}_{{ii}^{′}} ∉ {ℰ}_{tt}}} log ( p ( {e}_{i j} ) ) + log ( 1 - p ( {e}_{i {j}^{′}} ) ) , \qquad ( 5 )$$

$$where p ( {e}_{i j} ) = Sigmoid ( {h}_{i}^{T} \cdot {h}_{j} ) . \qquad ( 6 )$$

Advantageously, the GNN 150 is inductive, meaning that the GNN 150 does not need to be re-trained as often as conventional machine learning models in order to learn about new entities. Instead, once trained, the GNN 150 can be used to encode new entities, with the encoding capturing both the semantic and co-engagement aspects of the entity without fully re-training the GNN 150. For example, in some embodiments, the GNN 150 can be re-trained on new training data weekly, or even monthly.

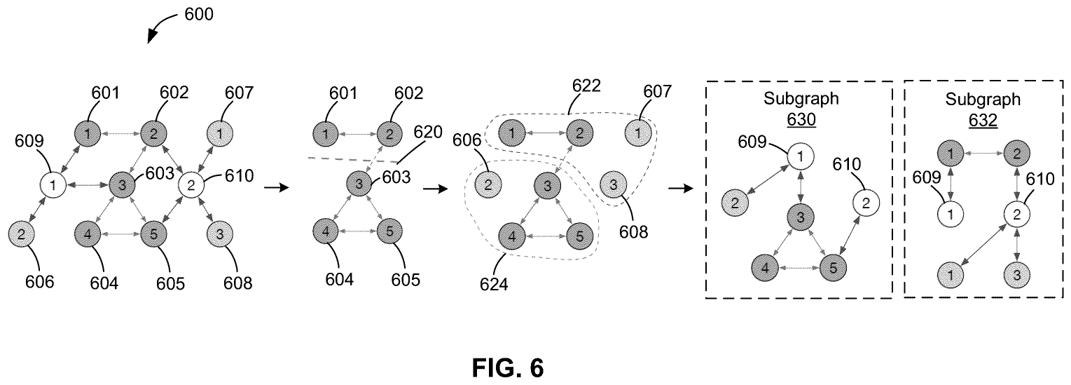

FIG. 6 illustrates how subgraphs can be generated for training a graph neural network across multiple processors, according to various embodiments. As shown, for a semantic knowledge graph 600, which can be generated in a similar manner as the semantic knowledge graph 410, described above in conjunction with FIG. 4, the training module 420 can generate subgraphs 630 and 632 that are stored in the memories of different processors (e.g., different GPUs) during training of the GNN 150 using those processors. The requisite number of subgraphs will generally depend on the number of processors and the amount of memory on each processor, and the number of subgraphs can be a user-specified parameter in some embodiments. Although described herein primarily with respect to generating subgraphs from semantic knowledge graphs as a reference example, techniques disclosed herein can be applied to generate subgraphs from any graphs having a similar topology in which a small percentage of nodes are linked to many other nodes and there are sparse links between other nodes.

Illustratively, the semantic knowledge graph 600 includes entity nodes 601, 602, 603, 604, 605, 606, 607, and 608, as well as concept nodes 609 and 610. The entity nodes 601, 602, 603, 604, 605, 606, 607, and 608 and the concept nodes 609 and 610 are similar to the entity nodes 412 and the concept nodes 414, respectively, of the semantic knowledge graph 410, described above in conjunction with FIGS. 4-5. The entity nodes 601, 602, 603, 604, and 605 of the semantic knowledge graph 600 are each linked to one or more other entity nodes via entity-entity links. The entity nodes 606, 607, and 608 are not linked to any other entity nodes.

To generate the subgraphs 630 and 632, the training module 420 first partitions the entity nodes 601, 602, 603, 604, and 605 that are linked to other entity nodes so as to maximize the co-engagement in each of the subgraphs 630 and 632 being generated. The goal is to generate N approximately uniform partitions of the subgraph that includes the entity nodes 601, 602, 603, 604, and 605 that are linked to other entity nodes, with minimized eliminations of entity-entity links between entity nodes. Here, N is a representation of a predetermined number of target partitions, which can be set to be a multiple of available processors (e.g., GPUs) and optimized in line with the memory capacity of the processors to ensure each subgraph can comfortably reside within the processor memories. In some embodiments, the training module 420 can perform a minimum cut graph partitioning technique to partition the entity nodes 601, 602, 603, 604, and 605. Illustratively, the entity nodes 601, 602, 603, 604, and 605 have been split 620 to form partitions 622 and 624.

After partitioning the entity nodes 601, 602, 603, 604, and 605 into the partitions 622 and 624, the training module 420 randomly assigns the other entity nodes 606, 607, and 608 that are not linked to any entity nodes to one of the partitions 622 or 624. Illustratively, the entity node 606 has been assigned to the partition 624, and the entity nodes 607 and 608 have been assigned to the partition 622. In some embodiments, assignment of the entity nodes that are not linked to any other entity nodes begins from a most sparsely populated partition, which helps to ensure a balanced distribution of entity nodes across all partitions, thereby equalizing the computational load. Doing so helps achieve the dual goals of minimal elimination of links between entity nodes and equitably distributed entity nodes. In some embodiments, entire entity node subgraphs, including both entity nodes that are linked to other entity nodes and entity nodes that are not linked to any entity nodes, are not partitioned in one go so as to prevent skewed distributions of links between entity nodes, where some partitions could be densely populated with entity nodes that are linked to other entity nodes while others might be bereft of such entity nodes, potentially undermining the generality of the resulting subgraphs.

Thereafter, the training module 420 generates, from the partitions 622 and 624, the subgraphs 632 and 630, respectively. Each of the subgraphs 632 and 630 includes the entity nodes from the partitions 622 and 624, respectively, as well as all of the concept nodes 609 and 610 from the semantic knowledge graph 600. Because the number of concept nodes 609 and 610 is relatively small compared to the number of entity nodes 601, 602, 603, 604, 605, 606, 607, and 608, adding all of the concept nodes 609 and 610 to each of the subgraphs 630 and 632 does not increase the size of the subgraphs 630 and 632 substantially. Further, adding all of the concept nodes helps ensure that all of the semantic information can be used in the message passing when a GNN is trained on each individual subgraph.

In some cases, the distinction between entity nodes and semantic nodes may blur. For example, when integrating external entities into a semantic knowledge graph to enrich semantic information, such entities may not neatly fit into a traditional semantic node category. Given their potentially vast quantities, duplicating such external entities, akin to how traditional semantic nodes are handled, can become impractical. In some embodiments, to address the foregoing issue, the training module 420 can permit a user-defined node sampling that allows users to specify and randomly sample a set number of nodes from particular node types. Doing so can offer context within the generated subgraphs while ensuring the subgraphs remain within memory constraints of the processors.

Each of the subgraphs 630 and 632 can be stored on a different processor (e.g., a different GPU) that would otherwise be unable to store the entire semantic knowledge graph 600, and the model trainer 116 can use the different processors together to train a GNN according to techniques disclosed herein. Accordingly, a GNN having heterogeneous nodes, with each node type having different feature sizes and degrees, can be effectively trained using multiple processors. In particular, in contrast to conventional approaches that may randomly assign nodes of the semantic knowledge graph 600 to subgraphs, the subgraphs 630 and 632 are generated to maximize the co-engagement in each subgraph and to include all of the concept nodes 609 and 610 in each subgraph. As a result, training of the GNN can converge to a more desirable result. Further data parallelism and flexibility are enabled, because the GNN can be trained on subgraphs across multiple processors, or a single processor can sequentially process the subgraphs using a dataloader.

FIG. 7 is a more detailed illustration of the application 146 of FIG. 1, according to various embodiments. As shown, the application 146 includes a graph generator module (graph generator) 702, the trained GNN 150, and a search/recommendation module 708. In operation, the application 146 takes as input the semantic information 122 and the user engagement information 124 from after the GNN 150 is trained, as well as user information 706 (e.g., a user query and/or other user information), and the application 146 generates one or more search results and/or recommendations 710.

Given the semantic information 122 and the user engagement information 124 from after the GNN 150 is trained, the graph generator 402 generates a semantic knowledge graph 710 from the semantic information 122 and the user engagement information 124. In some embodiments, the graph generator 402 can generate the semantic knowledge graph 710 in a similar manner as the graph generator 402 of the model trainer 116 generates the semantic knowledge graph 410, described above in conjunction with FIG. 4. For example, the application 146 could receive new semantic information and user engagement information and generate a semantic knowledge graph periodically (e.g., daily). In such cases, generating the semantic knowledge graph can include adding nodes and links to a previous semantic knowledge graph based on new semantic information and user engagement information that is received.

The application 146 inputs the semantic knowledge graph 710 into the trained GNN 150, which outputs embeddings (e.g., in the form of vectors) for entities 704 in the semantic knowledge graph 710. In some embodiments, the trained GNN 150 can, for each entity represented by a node in the semantic knowledge graph 710, take all of the neighboring nodes that are linked to the node representing the entity, apply weights that the trained GNN 150 computes, and then aggregate the results as a vector representing an embedding for the entity.

The search/recommendation module 708 then uses the entity embeddings 704 to generate the search results and/or recommendations 710. The search/recommendation module 708 can generate the search results and/or recommendations 710 in any technically feasible manner, including using one or more other trained machine learning models, in some embodiments. For example, in some embodiments, the search/recommendation module 708 can use the entity embeddings 704 to personalize search results for a particular user by ranking higher within the search results entities that are more similar, based on the entity embeddings 704, to entities that the user has engaged with previously. Any technically feasible similarity metric can be used in such cases. As another example, in some embodiments, the search/recommendation module 708 can generate a number of recommended entities that are most similar, based on the entity embeddings 704, to entities that a particular user has engaged with previously.

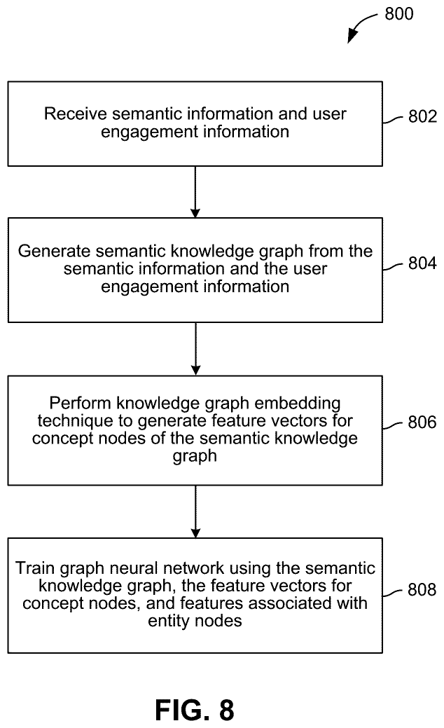

FIG. 8 illustrates a flow diagram of method steps for training a graph neural network using co-engagement and semantic information, according to various embodiments. Although the method steps are described in conjunction with the systems of FIGS. 1-7, persons of ordinary skill in the art will understand that any system configured to perform the method steps, in any order, is within the scope of the inventions.

As shown, a method 800 begins at step 802, where the model trainer 116 receives semantic information and user engagement information. The semantic information and user engagement information can be retrieved from any suitable location or locations, such as by querying the tables of a database, in some embodiments.

At step 804, the model trainer 116 generates a semantic knowledge graph from the semantic information and the user engagement information. In some embodiments, the semantic knowledge graph can include (1) entity nodes representing entities and (2) concept nodes representing semantic concepts, as well as (3) links between entity nodes and concept nodes representing semantic concepts that are associated with those entity nodes and (4) links between entity nodes and other entity nodes that are related based on co-engagement by users, as described above in conjunction with FIG. 4.

At step 806, the model trainer 116 performs a knowledge graph embedding technique to generate feature vectors for concept nodes of the semantic knowledge graph. Any technically feasible knowledge graph embedding technique can be performed in some embodiments. In some embodiments, the model trainer 116 can utilize a knowledge graph model and optimize a KG completion loss to generate the concept node feature vectors, as described above in conjunction with FIG. 5.

At step 808, the model trainer 116 trains a graph neural network (e.g., GNN 150) using the semantic knowledge graph, the feature vectors for concept nodes, and features associated with entity nodes. In some embodiments, the GNN is trained by updating parameters therein so as to minimize a similarity link prediction loss that is a calculated so that embeddings output by the GNN for entities whose nodes have an entity-entity link between them (i.e., entities associated with co-engagement by users) are close in distance in a latent space, and vice versa, as described above in conjunction with FIG. 5.

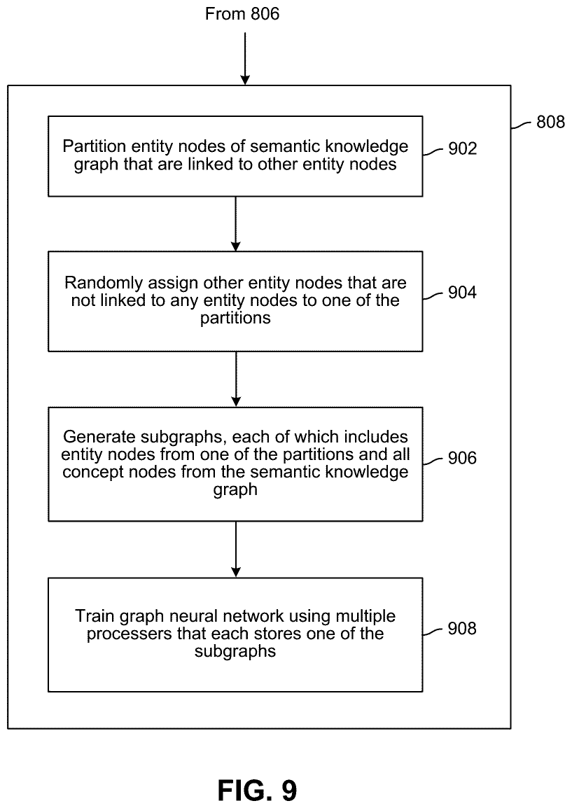

In some embodiments, the GNN can be trained across multiple processors, such as multiple GPUs, if the semantic knowledge graph is too large to be stored on a single processor. In such cases, the model trainer 116 can generate a number of subgraphs that are stored in memories of the different multiple processors during training of the GNN, as discussed in greater detail below in conjunction with FIG. 9.

FIG. 9 illustrates a flow diagram of method steps for training a graph neural network across multiple processors, according to various embodiments. Although the method steps are described in conjunction with the systems of FIGS. 1-7, persons of ordinary skill in the art will understand that any system configured to perform the method steps, in any order, is within the scope of the inventions.

As shown, at step 902, the model trainer 116 partitions entity nodes of a semantic knowledge graph that are linked to other entity nodes. In some embodiments, the model trainer 116 can partition the entity nodes that are linked to other entity nodes so as to maximize the co-engagement in each resulting subgraph. For example, in some embodiments, the model trainer 116 can perform a minimum cut graph partitioning technique to partition the entity nodes that are linked to other entity nodes, as described above in conjunction with FIG. 6.

At step 904, the model trainer 116 randomly assigns other entity nodes that are not linked to any entity nodes to one of the partitions generated at step 902. In some embodiments, assignment of the other entity nodes begins from a most sparsely populated partition, which helps to ensure a balanced distribution of entity nodes across all partitions, thereby equalizing the computational load.

At step 906, the model trainer 116 generates a number of subgraphs, each of which includes entity nodes from one of the partitions and all of the concept nodes from the semantic knowledge graph. As described, because the number of concept nodes can be relatively small compared to the number of entity nodes, adding all of the concept nodes to each of the subgraphs will generally not increase the size of the subgraphs substantially.

At step 908, the model trainer 116 trains a graph neural network using multiple processors that each stores one of the subgraphs. The training can use the semantic knowledge graph stored across the multiple processors, feature vectors for concept nodes, and features associated with entity nodes, as described above in conjunction with step 808 of FIG. 8.

FIG. 10 illustrates a flow diagram of method steps for generating search or recommendation results using a trained graph neural network, according to various embodiments. Although the method steps are described in conjunction with the systems of FIGS. 1-7, persons of ordinary skill in the art will understand that any system configured to perform the method steps, in any order, is within the scope of the inventions.

As shown, at step 1002, the application 146 receives semantic information and user engagement information. Similar to step 802 of the method 800, described above in conjunction with FIG. 8, in some embodiments, the semantic information and user engagement information can be retrieved from any suitable location or locations, such as by querying the tables of a database, after a GNN (e.g., GNN 150) has been trained.

At step 1004, the application 146 generates a semantic knowledge graph from the semantic information and the user engagement information. Step 1004 is similar to step 804 of the method 800, described above in conjunction with FIG. 8, except a semantic knowledge graph is generated using the semantic information and user engagement information received at step 1002.

At step 1006, the application 146 processes the semantic knowledge graph using a trained GNN (e.g., GNN 150) to generate embeddings (e.g., in the form of vectors) for entities. In some embodiments, the application 146 can input the semantic knowledge graph generated at step 1004 into the trained GNN, which outputs the embeddings for entities represented by nodes of the semantic knowledge graph. In such cases, the trained GNN can, for each entity represented by a node in the semantic knowledge graph, take all of the neighboring nodes that are linked to the node representing the entity, apply weights that the GNN computes, and then aggregate (e.g., compute a weighted average of) the results as a vector that represents an embedding for the entity.

At step 1008, the application 146 generates one or more search results or recommendations using the entity embeddings. Search result(s) and/or recommendations can be generated in any technically feasible manner, including using one or more other trained machine learning models, in some embodiments. For example, in some embodiments, the application 146 can use the embeddings to personalize search results for a particular user by ranking higher within the search result entities that are more similar, based on the entity embeddings, to entities that the user has engaged with previously. As another example, in some embodiments, the application 146 can determine a number of recommended entities that are most similar, based on the entity embeddings, to entities that a user has engaged with previously.

In sum, techniques are disclosed for training and utilizing a graph neural network that learns user co-engagement with entities and semantic concept relationships. In some embodiments, a model trainer generates a semantic knowledge graph from semantic information associated with entities and historical user engagement with the entities. The semantic knowledge graph includes entity nodes representing the entities, concept nodes representing semantic concepts, links between entity nodes and concept nodes representing semantic concepts that are associated with the entities represented by the entity nodes, and links between entity nodes representing entities associated with co-engagement by users. The model trainer performs a knowledge graph embedding technique to generate feature vectors for concept nodes of the semantic knowledge graph. Then, the model trainer trains a GNN using the semantic knowledge graph, the feature vectors for concept nodes, and features associated with entity nodes. When the semantic knowledge graph is too large to be stored within the memory of a single processor during training, the model trainer generates a number of subgraphs that are stored across different processors. In such cases, the model trainer can generate the subgraphs by partitioning entity nodes in the semantic knowledge graph that are linked to other entity nodes into multiple partitions, randomly assigning each other entity node that is not linked to any entity nodes to one of the partitions, and generating each of the subgraphs to include the entity nodes from one of the partitions and all of the concept nodes in the semantic knowledge graph.

Once the GNN is trained, another semantic knowledge graph, which is created from updated semantic information and user engagement information, can be input into the trained GNN to generate embeddings of entities represented by nodes of the semantic knowledge graph. The entity embeddings can then be used by an application in any technically feasible manner, such as to generate search results or recommendations of entities.

At least one technical advantage of the disclosed techniques relative to the prior art is that the disclosed techniques train a graph neural network to correctly learn both the relationships between entities and semantic concepts as well as co-engagement relationships. In particular, the graph neural network is able to capture graph relationships and spatial locality better than conventional machine learning models. The graph neural network is also inductive, meaning that the graph neural network does not need to be re-trained as often as conventional machine learning models in order to learn about new entities. Instead, the previously trained graph neural network can be used to encode new entities, with the encoding capturing both the semantic and co-engagement aspects of the entity without fully re-training the graph neural network. In addition, the disclosed techniques enable the graph neural network to be effectively trained by distributing the training across multiple processors, such as multiple GPUs. These technical advantages represent one or more technological improvements over prior art approaches.
1. In some embodiments, a computer-implemented method for training a machine learning model comprises generating a graph based on one or more semantic concepts associated with a plurality of entities and user engagement with the plurality of entities, and performing one or more operations to train an untrained machine learning model based on the graph to generate a trained machine learning model.
2. The computer-implemented method of clause 1, wherein the machine learning model comprises a graph neural network.
3. The computer-implemented method of clauses 1 or 2, wherein the graph includes a first set of nodes representing the plurality of entities and a second set of nodes representing the one or more semantic concepts, and performing the one or more operations to train the untrained machine learning model comprises generating a plurality of subgraphs based on the graph, wherein each subgraph included in the plurality of subgraphs includes the second set of nodes and a different subset of nodes from the first set of nodes, and training the untrained machine learning model using a plurality of processors, wherein each processor included in the plurality of processors stores a different subgraph included in the plurality of subgraphs.
4. The computer-implemented method of any of clauses 1-3, wherein generating the plurality of subgraphs comprises partitioning a first subset of nodes included in the first set of nodes into a plurality of partitions, wherein each node included in the first subset of nodes is linked within the graph to at least one other node included in the first set of nodes, assigning each node included in a second subset of nodes included in the first set of nodes to one partition included in the plurality of partitions, and adding the second set of nodes to each partition included in the plurality of partitions.
5. The computer-implemented method of any of clauses 1-4, wherein the graph includes a first set of nodes representing the plurality of entities and a second set of nodes representing the one or more semantic concepts, and performing the one or more operations to train the untrained machine learning model comprises generating one or more feature vectors for the second set of nodes, and training the untrained machine learning model based on the graph, the one or more feature vectors, and one or more features associated with plurality of entities.
6. The computer-implemented method of any of clauses 1-5, wherein generating the one or more feature vectors comprises performing one or more knowledge graph embedding operations based on the graph.
7. The computer-implemented method of any of clauses 1-6, wherein the one or more operations to train the untrained machine learning model are further based on a loss that reduces a distance within a latent space between at least two entities represented by at least two nodes included in the graph that are linked to one another.
8. The computer-implemented method of any of clauses 1-7, wherein the graph includes a plurality of first nodes representing the plurality of entities, one or more second nodes representing the one or more semantic concepts, one or more first links between at least one first node included in the plurality of first nodes and at least one other first node included in the plurality of first nodes, and one or more second links between at least one second node included in the one or more second nodes and at least one first node included in the plurality of first nodes.
9. The computer-implemented method of any of clauses 1-8, further comprising processing another graph using the trained machine learning model to generate a plurality of embeddings associated with another plurality of entities, and generating one or more search results based on the plurality of embeddings.
10. The computer-implemented method of any of clauses 1-9, further comprising processing another graph using the trained machine learning model to generate a plurality of embeddings associated with another plurality of entities, and generating one or more recommendations based on the plurality of embeddings.
11. In some embodiments, one or more non-transitory computer-readable media store instructions that, when executed by at least one processor, cause the at least one processor to perform steps comprising generating a graph based on one or more semantic concepts associated with a plurality of entities and user engagement with the plurality of entities, and performing one or more operations to train an untrained machine learning model based on the graph to generate a trained machine learning model.
12. The one or more non-transitory computer-readable media of clause 11, wherein the machine learning model comprises a graph neural network.
13. The one or more non-transitory computer-readable media of clauses 11 or 12, wherein the graph includes a first set of nodes representing the plurality of entities and a second set of nodes representing the one or more semantic concepts, and performing the one or more operations to train the untrained machine learning model comprises generating a plurality of subgraphs based on the graph, wherein each subgraph included in the plurality of subgraphs includes the second set of nodes and a different subset of nodes from the first set of nodes, and training the untrained machine learning model using a plurality of processors, wherein each processor included in the plurality of processors stores a different subgraph included in the plurality of subgraphs.
14. The one or more non-transitory computer-readable media of any of clauses 11-13, wherein generating the plurality of subgraphs comprises partitioning a first subset of nodes included in the first set of nodes into a plurality of partitions, wherein each node included in the first subset of nodes is linked within the graph to at least one other node included in the first set of nodes, assigning each node included in a second subset of nodes included in the first set of nodes to one partition included in the plurality of partitions, and adding the second set of nodes to each partition included in the plurality of partitions.
15. The one or more non-transitory computer-readable media of any of clauses 11-14, wherein generating the plurality of subgraphs is further based on a user-specified subset of the first set of nodes.
16. The one or more non-transitory computer-readable media of any of clauses 11-15, wherein the graph includes a first set of nodes representing the plurality of entities and a second set of nodes representing the one or more semantic concepts, and performing the one or more operations to train the untrained machine learning model comprises generating one or more feature vectors for the second set of nodes, and training the untrained machine learning model based on the graph, the one or more feature vectors, and one or more features associated with plurality of entities.
17. The one or more non-transitory computer-readable media of any of clauses 11-16, wherein the trained machine learning model includes one or more weights that are aware of one or more types of semantic relationships.
18. The one or more non-transitory computer-readable media of any of clauses 11-17, wherein the instructions, when executed by the at least one processor, further cause the at least one processor to perform the steps of processing another graph using the trained machine learning model to generate a plurality of embeddings associated with another plurality of entities, and generating at least one search result or recommendation based on the plurality of embeddings.
19. The one or more non-transitory computer-readable media of any of clauses 11-18, wherein the plurality of entities includes at least one media content title, person, or book.
20. In some embodiments, a system comprises one or more memories storing instructions, and one or more processors coupled to the one or more memories that, when executing the instructions, perform the steps of generate a graph based on one or more semantic concepts associated with a plurality of entities and user engagement with the plurality of entities, and perform one or more operations to train an untrained machine learning model based on the graph to generate a trained machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model, the method comprising:
generating a graph based on one or more semantic concepts associated with a plurality of entities and user engagement with the plurality of entities; and
performing one or more operations to train an untrained machine learning model based on the graph to generate a trained machine learning model.

2. The computer-implemented method of claim 1, wherein the machine learning model comprises a graph neural network.

3. The computer-implemented method of claim 1, wherein the graph includes a first set of nodes representing the plurality of entities and a second set of nodes representing the one or more semantic concepts, and performing the one or more operations to train the untrained machine learning model comprises:
generating a plurality of subgraphs based on the graph, wherein each subgraph included in the plurality of subgraphs includes the second set of nodes and a different subset of nodes from the first set of nodes; and
training the untrained machine learning model using a plurality of processors, wherein each processor included in the plurality of processors stores a different subgraph included in the plurality of subgraphs.

4. The computer-implemented method of claim 3, wherein generating the plurality of subgraphs comprises:
partitioning a first subset of nodes included in the first set of nodes into a plurality of partitions, wherein each node included in the first subset of nodes is linked within the graph to at least one other node included in the first set of nodes;
assigning each node included in a second subset of nodes included in the first set of nodes to one partition included in the plurality of partitions; and
adding the second set of nodes to each partition included in the plurality of partitions.

5. The computer-implemented method of claim 1, wherein the graph includes a first set of nodes representing the plurality of entities and a second set of nodes representing the one or more semantic concepts, and performing the one or more operations to train the untrained machine learning model comprises:
generating one or more feature vectors for the second set of nodes; and
training the untrained machine learning model based on the graph, the one or more feature vectors, and one or more features associated with plurality of entities.

6. The computer-implemented method of claim 5, wherein generating the one or more feature vectors comprises performing one or more knowledge graph embedding operations based on the graph.

7. The computer-implemented method of claim 1, wherein the one or more operations to train the untrained machine learning model are further based on a loss that reduces a distance within a latent space between at least two entities represented by at least two nodes included in the graph that are linked to one another.

8. The computer-implemented method of claim 1, wherein the graph includes a plurality of first nodes representing the plurality of entities, one or more second nodes representing the one or more semantic concepts, one or more first links between at least one first node included in the plurality of first nodes and at least one other first node included in the plurality of first nodes, and one or more second links between at least one second node included in the one or more second nodes and at least one first node included in the plurality of first nodes.

9. The computer-implemented method of claim 1, further comprising:
processing another graph using the trained machine learning model to generate a plurality of embeddings associated with another plurality of entities; and
generating one or more search results based on the plurality of embeddings.

10. The computer-implemented method of claim 1, further comprising:
processing another graph using the trained machine learning model to generate a plurality of embeddings associated with another plurality of entities; and
generating one or more recommendations based on the plurality of embeddings.

11. One or more non-transitory computer-readable media storing instructions that, when executed by at least one processor, cause the at least one processor to perform steps comprising:
generating a graph based on one or more semantic concepts associated with a plurality of entities and user engagement with the plurality of entities; and
performing one or more operations to train an untrained machine learning model based on the graph to generate a trained machine learning model.

12. The one or more non-transitory computer-readable media of claim 11, wherein the machine learning model comprises a graph neural network.

13. The one or more non-transitory computer-readable media of claim 11, wherein the graph includes a first set of nodes representing the plurality of entities and a second set of nodes representing the one or more semantic concepts, and performing the one or more operations to train the untrained machine learning model comprises:
generating a plurality of subgraphs based on the graph, wherein each subgraph included in the plurality of subgraphs includes the second set of nodes and a different subset of nodes from the first set of nodes; and
training the untrained machine learning model using a plurality of processors, wherein each processor included in the plurality of processors stores a different subgraph included in the plurality of subgraphs.

14. The one or more non-transitory computer-readable media of claim 13, wherein generating the plurality of subgraphs comprises:
partitioning a first subset of nodes included in the first set of nodes into a plurality of partitions, wherein each node included in the first subset of nodes is linked within the graph to at least one other node included in the first set of nodes;
assigning each node included in a second subset of nodes included in the first set of nodes to one partition included in the plurality of partitions; and
adding the second set of nodes to each partition included in the plurality of partitions.

15. The one or more non-transitory computer-readable media of claim 13, wherein generating the plurality of subgraphs is further based on a user-specified subset of the first set of nodes.

16. The one or more non-transitory computer-readable media of claim 11, wherein the graph includes a first set of nodes representing the plurality of entities and a second set of nodes representing the one or more semantic concepts, and performing the one or more operations to train the untrained machine learning model comprises:
generating one or more feature vectors for the second set of nodes; and
training the untrained machine learning model based on the graph, the one or more feature vectors, and one or more features associated with plurality of entities.

17. The one or more non-transitory computer-readable media of claim 11, wherein the trained machine learning model includes one or more weights that are aware of one or more types of semantic relationships.

18. The one or more non-transitory computer-readable media of claim 11, wherein the instructions, when executed by the at least one processor, further cause the at least one processor to perform the steps of:
processing another graph using the trained machine learning model to generate a plurality of embeddings associated with another plurality of entities; and
generating at least one search result or recommendation based on the plurality of embeddings.

19. The one or more non-transitory computer-readable media of claim 11, wherein the plurality of entities includes at least one media content title, person, or book.

20. A system, comprising:
one or more memories storing instructions; and
one or more processors coupled to the one or more memories that, when executing the instructions, perform the steps of:
generate a graph based on one or more semantic concepts associated with a plurality of entities and user engagement with the plurality of entities, and
perform one or more operations to train an untrained machine learning model based on the graph to generate a trained machine learning model.
